(19) United States
(12) Patent Application Publication
(10) Pub. No.: US 2011/0146464 A1
(43) Pub. Date: Jun. 23, 2011

(54) CLAMPING MEMBER FOR PORTABLE AND REPLACEABLE BIT ASSEMBLY

(76) Inventor: HUNG-MING HU, TAINAN HSIEN (TW)

(21) Appl. No.: 12/644,471

(22) Filed: Dec. 22, 2009

(51) Int. Cl. B25B 23/00

(52) U.S. Cl. 81/184; 81/438

(57) ABSTRACT

The clamping member for a bit assembly of the present invention improves the drawback that the clamping piece cannot be replaced and is easily damaged of the conventional bit assembly. The bit assembly includes a tubular body having at least one reception recess, at least one shank inserted into the at least one reception recess and including at least one bit. At least one clamping member is engaged with the at least one reception recess and includes a plurality of flexible clamping plates extending from one of two ends thereof. The clamping plates extend gradually toward a central axis of the clamping member and hold the at least one shank during use. The at least one clamping member can be replaced with a new one.

### FIELD OF THE INVENTION

The present invention relates to a bit clamping member, and more particularly, to a clamping member for a portable and replaceable bit assembly, wherein bit shanks are secured by clamping plates and easily changed.

### BACKGROUND OF THE INVENTION

A conventional portable bit assembly is shown in FIG. 5 and generally includes a shank “A” which has a fist bit “A1” on one end or a second bit “A2” on the other end of the shank “A”. Two caps “B’ are respectively mounted to the two ends of the shank “A” so as to accommodate the first and second bits “A1”, “A2” therein. By the caps “B”, the user is protected from being injured by the first and second bits “A1”, “A2”, and further the first and second bits “A1”, “A2” are protected from being damaged. However, the first and second bits “A1”, “A2” are integrally connected to the shank “A” so that there are only two bits can be used.

A conventional portable bit assembly known to applicant includes a handle, a clamping piece, a sleeve, a shank and a bit, all of which are assembled to be a pen-like bit assembly. The handle includes a hexagonal inner recess and the clamping piece is located at the inside of the recess so as to position the shank inserted in the recess. The shank can be easily shifted so as to use the different bits thereon.

However, the clamping piece located at the inside of the recess may be loosened if the shank is pulled out and inserted into the recess frequently, or if the user applies abnormal force when using the shank, the clamping piece cannot securely clamp the shank properly.

Another conventional portable bit assembly known to applicant includes a handle, a shank connected to the handle, and a cap, wherein the shank includes a driving end on at least one end thereof and the handle includes a recess defined axially in at least one end thereof so that the shank can be inserted into the recess. A radial hole is defined through the wall of the handle and communicates with the recess. A curved spring plate is received in the radial hole and includes a protrusion on an inside thereof. When the shank is inserted into the recess, the protrusion on the spring plate will hold against the shank to position the shank. The shank can easily be pulled out from the recess and release the contact of the spring plate. The cap is mounted to one end of the handle.

Nevertheless, the spring plate is going to be fatigued or loosened after frequent uses and if the spring plate is damaged or broken, it cannot be replaced. The whole handle has to be replaced. This is not an economical design.

The present invention intends to provide a clamping member for a portable and replaceable bit assembly, and the clamping member improves the shortcomings of the conventional portable bit assemblies.

### SUMMARY OF THE INVENTION

The present invention relates to a bit assembly and comprises a tubular body, at least one shank, and at least one clamping member. The tubular body includes at least one reception recess. The at least one shank is inserted into the at least one reception recess and includes at least one bit. The at least one clamping member is engaged with the at least one reception recess and has two open ends. A plurality of clamping plates extend from one of the two ends of the at least one clamping member and gradually toward a central axis of the clamping member. The clamping plates are flexible and the at least one shank extends through the at least one clamping member and the plurality clamping plates hold the at least one shank.

The clamping member provides a convenient replacement of the shank and a secured connection between the shank and the tubular body. The bits can be operated in a stable status. When the clamping member is damaged, only the clamping member needs to be replaced.

Preferably, the tubular body has a first reception recess and a second reception recess defined in two ends thereof, and each of the first and second reception recesses has one clamping member engaged therewith. Two shanks extend through the two clamping members.

Preferably, the at least one reception recess has a shoulder extending inward from an inner periphery thereof and the at least one clamping member is engaged with the shoulder.

Preferably, at least one cap is connected to the tubular body so as to accommodate the bit and protects the user from being injured by the bit.

The clamping member is engaged with the shoulder in the reception recess and includes multiple outsides which are securely engaged with the insides of the reception recess. The shank is securely positioned by the clamping member and can be operated in a stable status. When replacing the shank, the shank can be pulled out from the clamping member. When the clamping member is damaged, it is located at the opening of the reception recess so that it is easily to be replaced while the whole tubular body is maintained.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the clamping member of the present invention;

FIG. 2 is an exploded view to show the bit assembly and the clamping members of the present invention;

FIG. 3 is a perspective view to show the bit assembly of the present invention;

FIG. 4 is a cross sectional view, taken along line A-A in FIG. 3;

FIG. 5 is a perspective view of a conventional bit assembly.

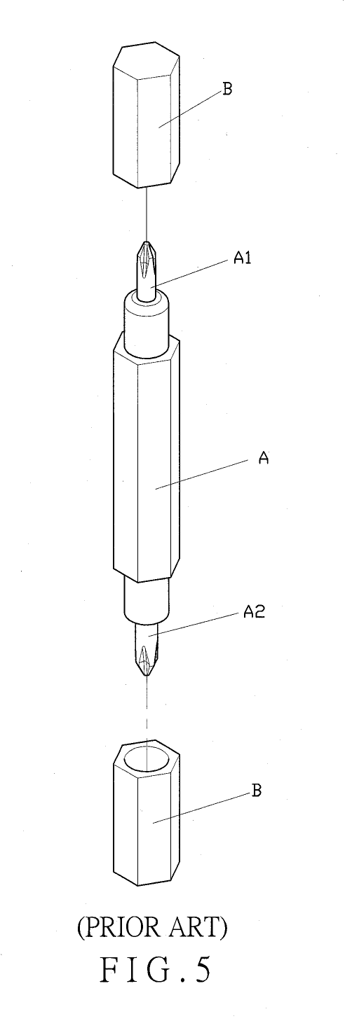

### DETAILED DESCRIPTION OF THE PREFERRED EMBODIMENT

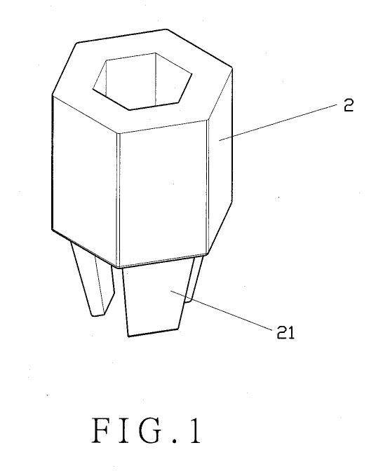

Referring to FIG. 1, the clamping member 2 of the present invention comprises a passage defined axially therethrough so as to define two open ends and the passage includes a plurality of insides. The clamping member 2 includes a plurality of outsides and a plurality of flexible clamping plates 21 extend from one of the two ends of the clamping member 2. The clamping plates 21 extend gradually toward a central axis of the clamping member 2,

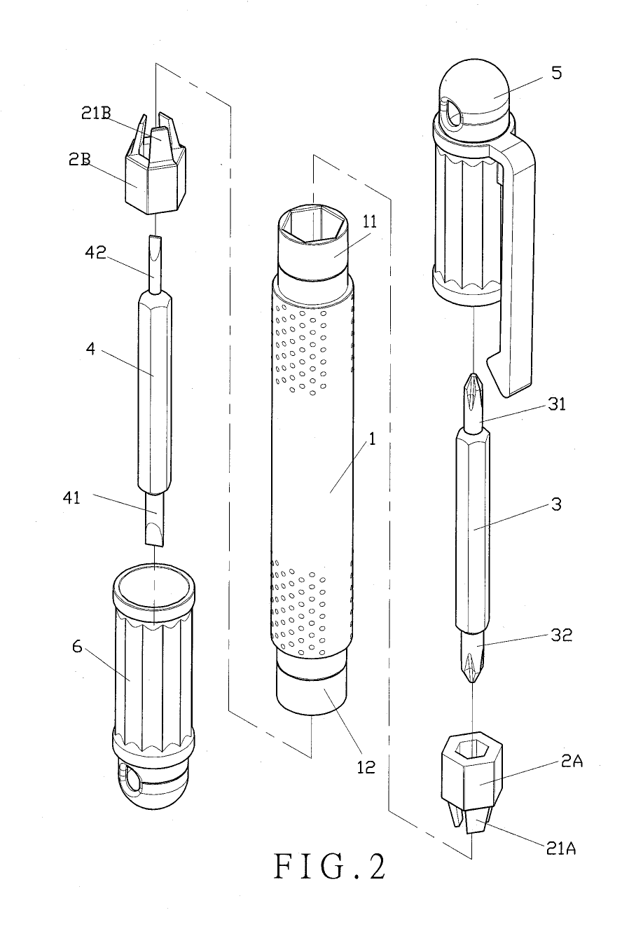

FIGS. 2 to 4 disclose a preferable embodiment of the present invention and the clamping members 2 are used in a bit assembly which comprises a tubular body, at least one clamping member and a number of shanks, wherein the tubular body has at least one reception recess. Each reception recess has a clamping member engaged therewith the each clamping member has a shank extending therethrough. Caps are connected to the tubular body.

In the embodiment disclosed, the bit assembly comprises a tubular body 1, a first clamping member 2A, a second clamping member 2B, a first shank 3, a second shank 4, a first cap 5 and a second cap 6.

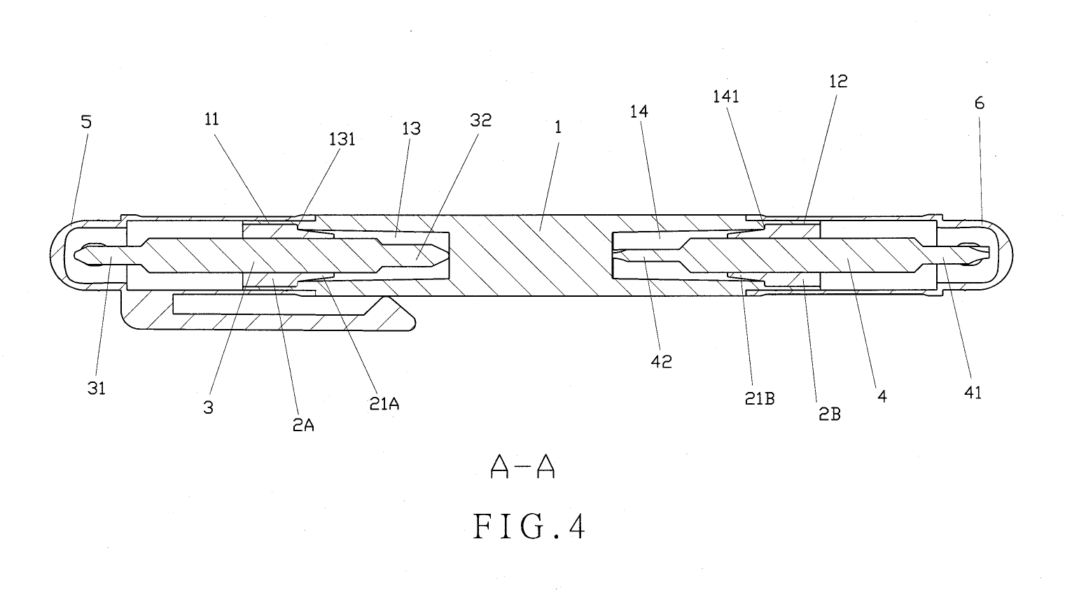

Referring to FIG. 4, the tubular body 1 includes a first end 11 and a second end 12, wherein a first reception recess 13 and a second reception recess 14 are defined in the first and second ends 11, 12 respectively. The first reception recess 13 includes an inner periphery including multiple insides and a first shoulder 131 extending inward from the insides of the first reception recess 13. The second reception recess 14 includes an inner periphery including multiple insides and a second shoulder 141 extending inward from the insides of the second reception recess 14.

The first clamping member 2A is inserted into the first reception recess 13 by engaging the outsides of the first clamping member 2A with the insides of the first reception recess 13. The first clamping member 2A is engaged with the first shoulder 131. The first clamping member 2A includes two open ends and a plurality of first clamping plates 21A extend from one of the two ends of the first clamping member 2A and gradually toward a central axis of the first clamping member 2A.

The second clamping member 2B is inserted into the second reception recess 14 by engaging the outsides of the second clamping member 2B with the insides of the second reception recess 14. The second clamping member 2B is engaged with the second shoulder 141. The second clamping member 2B includes two open ends and a plurality of second clamping plates 21B extend from one of the two ends of the second clamping member 2B and gradually toward a central axis of the clamping member 2B.

The first clamping plates 21A hold the first shank 3. A first bit 31 of the first shank 3 extends out from the first reception recess 13, and a second bit 32 of the first shank 3 is located in the first reception recess 13 of the tubular body 1.

The second clamping plates 21B hold the second shank 4. A third bit 41 of the second shank 4 extends out from the second reception recess 14, and a fourth bit 42 of the second shank 4 is located in the second reception recess 14 of the tubular body 1.

The first cap 5 and the second cap 6 are respectively mounted on the first and second ends 11, 12 of the tubular body 1.

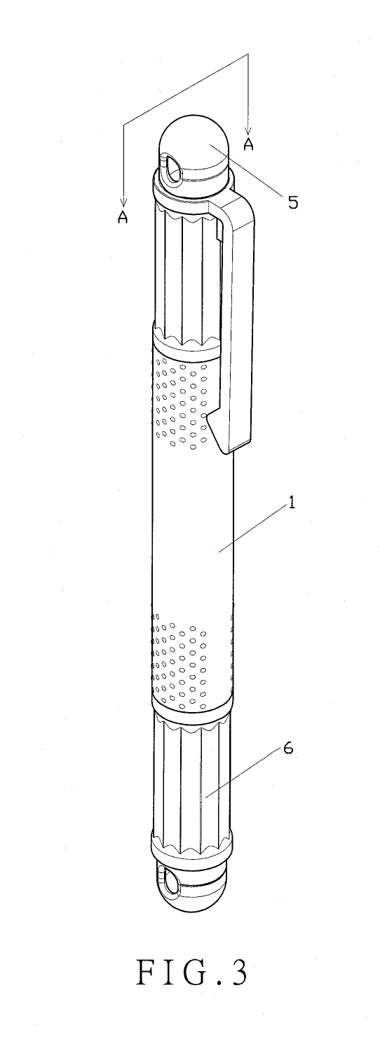

As disclosed in FIGS. 3 and 4, the user can choose one of the first and second bits 31, 32 of the first shank 3, or one of the third and fourth bits 41, 42 of the second shank 4 to use. The first shank 3 is securely positioned by the first clamping plates 21A of the first clamping member 2A, and the second shank 4 is securely positioned by the second clamping plates 21B of the second clamping member 2B. Therefore, the first and second shanks 3, 4 are in a stable status when in use.

When the first or second clamping members 2A, 2B needs to be replaced due to looseness or damage, the first or second clamping members 2A, 2B can be replaced individually, while the tubular body 1 is maintained and needs not to be replaced.

While we have shown and described the embodiment in accordance with the present invention, it should be clear to those skilled in the art that further embodiments may be made without departing from the scope of the present invention.

What is claimed is:

1. A bit assembly, comprising:
a tubular body having at least one reception recess;
at least one shank inserted into the at least one reception recess and including at least one bit, and
at least one clamping member engaged with the at least one reception recess of the tubular body, the at least one clamping member having two open ends and a plurality of clamping plates extending from one of the two ends of the at least one clamping member and gradually toward a central axis of the clamping member, the clamping plates being flexible, the at least one shank extending through the at least one clamping member and the plurality clamping plates holding the at least one shank.

2. The assembly as claimed in claim 1, wherein the tubular body has a first reception recess and a second reception recess defined in two ends thereof, each of the first and second reception recesses has one clamping member engaged therewith, two shanks extend through the two clamping members.

3. The assembly as claimed in claim 1, wherein the at least one reception recess has a shoulder extending inward from an inner periphery thereof and the at least one clamping member is engaged with the shoulder.

4. The assembly as claimed in claim 1, further comprising at least one cap connected to the tubular body.
